(19) United States
(12) Patent Application Publication
(10) Pub. No.: US 2023/0086211 A1
(43) Pub. Date: Mar. 23, 2023

(54) REFERRAL SYSTEM AND METHOD

(71) Applicant: Audish, Inc., New York, NY (US)

(72) Inventor: Nithin Meppurathu, Lake Mary, FL (US)

(21) Appl. No.: 17/948,483

(22) Filed: Sep. 20, 2022

Related U.S. Application Data
(60) Provisional application No. 63/261,362, filed on Sep. 20, 2021.

(51) Int. Cl. G06Q 10/10; G06F 16/44

(52) U.S. Cl. CPC G06Q 10/1053; G06F 16/44

(57) ABSTRACT

The present invention comprises a mobile interface process that utilizes mobile camera tools to create pre-recorded mobile video. The process accentuates customary referral interactions between businesses and candidates during the online recruitment process with software. Candidates initiate the process by requesting referrals from their peers. The referrer responds by using mobile camera tools to record a 30 second referral, as an example. The referral is audiovisual content that includes human speech as well as text-based descriptions of the content. When completed to the referrer's standards, the referral is delivered to the candidate for approval. When the referral is approved it becomes associated with and viewable on the candidate's profile. Businesses performing diligence on the candidate may then view the referral video.

### CROSS REFERENCE TO RELATED APPLICATIONS

The present application claims priority to U.S. provisional patent application 63/261,362, entitled REFERRAL SYSTEM AND METHOD filed Sep. 20, 2021, which is hereby incorporated by reference.

### FIELD OF THE INVENTION

The present invention relates to novel mobile interface processes that advance how job candidates communicate their referrals to hiring businesses during the online recruitment process. In particular, the invention relates to the innovative use of pre-recorded mobile video.

### BACKGROUND

In the world of online recruitment, there are dozens of mobile and desktop applications matching businesses in need of employees with candidates seeking employment. However, the vast majority of applications were developed over two decades ago when online communication was desktop- and text-based. Unfortunately, new innovations in the online recruitment ecosystem have remained text-based. The rest of human connectivity applications have moved on to mobile video.

An example of video being used as an aspect of online recruitment can be seen in patent application Ser. No. 16/406,893 filed on May 8, 2019 by Baidu Online Network Technologies, LTD, which describes a structure and method where a computer-assisted device receives information about both a job as well as a plurality of applicants, then matches the best-suited candidate to the job via a video-interview process. While the interview is an important aspect of the process, afterwards, the candidate is customarily responsible for submitting at least three (3) references, which the business then has to schedule and conduct over phone for reference checks.

In any online recruitment process, the interview is just another step on the way to either moving a candidate forward in the process or abandoning them. A business requesting referrals from a candidate is a critical signal to the candidate and a crucial step in concluding the process. Yet, this step is still conducted over email exchanges and telephone calls in a mobile-video world.

Therefore, a need exists for a novel process that leverages today's mobile video technology to capture and communicate referrals by hiring businesses (or by other entities that utilize references), thereby accelerating the process and saving crucial time.

### BRIEF SUMMARY OF THE INVENTION

Systems and method in accordance with the inventive concepts leverage a mobile video user interface (UI) to power its online recruitment processes. These processes enable candidates to perform various operations through a platform that facilitates and manages the technological aspects of the referral process. In one embodiment, as an example, a candidate requests a 30 pre-recorded mobile video referral from his or her peer group, or from one or more members of his or her peer group. Once a recorded video referral is received, the recorded referral is then associated with the requesting candidate's profile.

Referrals, typically three (3), are a customary request of a business that is conducting diligence on a candidate. The referral aspect of recruitment takes place well into the recruitment process, and is typically a second- or third-order diligence instance. Through the present invention's mobile interface processes, referrals are instantly available to the hiring business.

In accordance with an aspect of the inventive concepts, provided is a referral system, comprising a referral application executable on or via a mobile device and a computer-based referral platform configured to store and manage a plurality of user profiles and to communicate with a plurality of mobile devices executing the referral application. The referral application is responsive to a user input via a user profile on a user mobile device to generate an Endorsement request to one or more mobile devices of endorsing users, the Endorsement request soliciting an audiovisual input from the endorsing users of the one or more other mobile devices. And the referral application is executable to activate a microphone and camera on the one or more other mobile devices to record audiovisual inputs from the endorsing users as recorded Endorsements responsive to the Endorsement request.

In various embodiments, the referral application is executable to communicate the recorded Endorsements from the one or more other mobile devices of the endorsing users to the user mobile device and/or the referral platform.

In various embodiments, the referral application and/or the referral platform are responsive to a user input via the referral application to communicate an electronic message to at least one referral-requesting system indicating availability of one or more of the recorded Endorsements.

In various embodiments, the electronic message includes at least one Endorsement and/or an active link to at least one Endorsement.

In various embodiments, the referral application and/or the referral platform are configured to generate a message to the mobile device of the user indicating that the at least one Endorsement has been downloaded or executed (played).

In various embodiments, the referral application is configured to impose a predetermined time constraint to the audiovisual recordings.

In accordance with another aspect of the inventive concepts, provided is a computer-based referral method, comprising: providing a referral application executable on or via a mobile device; providing a computer-based referral platform configured to store and manage a plurality of user profiles and to communicate with a plurality of mobile devices executing the referral application; in response to a user input via a user profile on a user mobile device, the referral application generating an Endorsement request to one or more mobile devices of endorsing users, the Endorsement request soliciting an audiovisual input from the endorsing users of the one or more other mobile devices; and the referral application activating a microphone and camera on the one or more other mobile devices to record audiovisual inputs from the endorsing users as recorded Endorsements responsive to the Endorsement request.

In various embodiments, the method further comprises the referral application communicating the recorded Endorsements from the one or more other mobile devices of the endorsing users to the user mobile device and/or the referral platform.

In various embodiments, the method further comprises, in response to a user input via the referral application, the referral application and/or the referral platform communicating an electronic message to at least one referral-requesting system indicating availability of one or more of the recorded Endorsements.

In various embodiments, the electronic message includes at least one Endorsement and/or an active link to at least one Endorsement.

In various embodiments, the method further comprises the referral application and/or the referral platform generating a message to the mobile device of the user indicating that the at least one Endorsement has been downloaded or executed (played).

In various embodiments, the method further comprises the referral application imposing a predetermined time constraint to the audiovisual recordings.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 depicts an embodiment of a log-in page to the mobile application where users can either sign up or log in to utilize the present invention's referral process (“Endorsements”).

FIG. 2 depicts an embodiment of a user profile within the mobile application where users can engage with an Endorsements process through in-app functionality, such as search, view profile, and direct message.

FIG. 3 depicts an embodiment of a search page of the application, where users may engage in search through one or more primary search protocols, e.g., Users/Candidate, Companies, and/or Opportunities.

FIG. 4 depicts an embodiment of a User/Candidate search protocol in its selected state.

FIG. 5 depicts an embodiment of a User/Candidate search protocol in its selected state with the primary user utilizing the operating system's native keyboard to input text.

FIG. 6 depicts an embodiment of a returned User/Candidate search page based on the primary user's text entry.

FIG. 7 depicts an embodiment of a User profile discovered after a search has been conducted as well as the application's direct-message functionality.

FIG. 8 depicts an embodiment of an instant message exchange within the mobile application where the primary user messages the engaged user to request an Endorsement.

FIG. 9 illustrates an embodiment of an initialization of the Endorsement process after the engaged user visits the primary user's profile, wherein initialization instructions can be presented via a text overlay.

FIG. 10 depicts an embodiment of the mobile application's system messaging (“New Endorsement”) to prompt the engaged user to create an Endorsement for the primary user, triggering the application's recording process.

FIG. 11 depicts an embodiment of the mobile applications recording screen and camera tools to create the Endorsement.

FIG. 12 depicts an embodiment of the mobile application's additional camera tools and filters.

FIG. 13 depicts an embodiment of the mobile application's processing screen, after the engaged user has finalized their Endorsement recording.

FIG. 14 depicts an embodiment of the mobile application's Endorsement share screen, where the engaged user can share the Endorsement with the primary user or save as a draft.

FIG. 15 depicts an embodiment of the mobile application's notification screen, notifying the primary user that the engaged user has submitted their Endorsement for review.

FIG. 16 depicts an embodiment of the primary user's profile screen, where the primary user may choose to associate the engaged user's Endorsement with their profile for public consumption.

FIG. 17 depicts an embodiment of the primary user's profile screen with the quantified Endorsement statistics.

FIG. 18 is a diagram of a referral system in accordance with aspects of the inventive concepts.

### DETAILED DESCRIPTION OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing aspects of the inventive concepts, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New mobile processing interfaces for online recruitment and candidate referrals are discussed herein. In the following description, for purposes of explanation, numerous specific details are set forth in order to provide a thorough understanding of the inventive concepts. It will be evident, however, to one skilled in the art that the present invention may be practiced without these specific details.

The present disclosure is to be considered as an exemplification of aspects of the inventive concepts, and is not intended to limit the invention to the specific embodiments illustrated by the figures or description below.

Aspects of the inventive concepts will now be described by referencing the appended figures representing preferred embodiments.

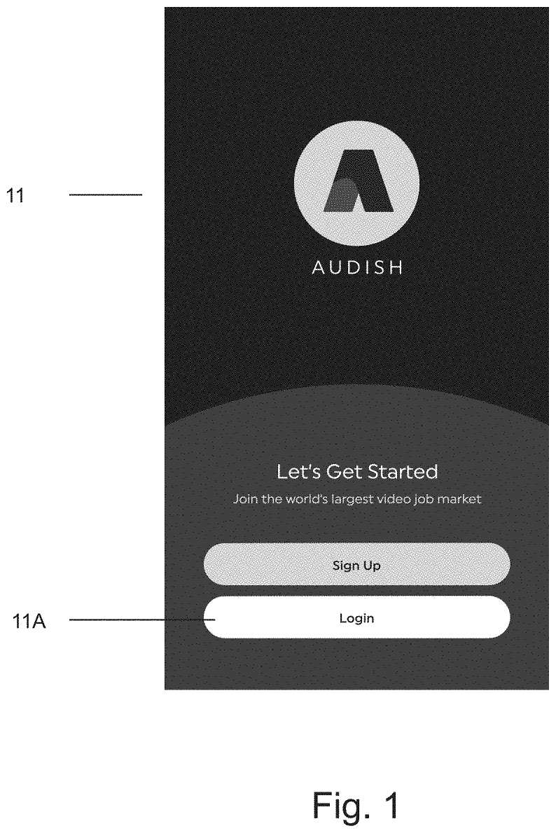

FIG. 1 depicts an embodiment of a login page 11 of the mobile application, which serves as a user interface (UI) to the access and interact with various functions related to the inventive concepts. A login button 11A is accompanied by a Sign Up button for users who have not previously accessed the system.

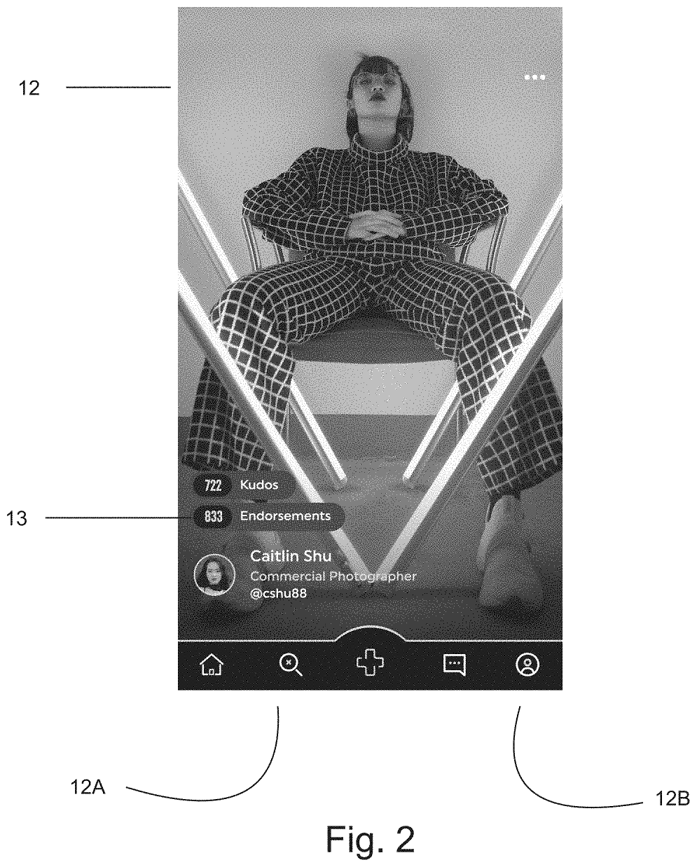

FIG. 2 depicts an example profile 12 that can be created and/or accessed within the mobile application. The user profile contains multiple functionalities made accessible to the user including, as examples, the name of the profile or user, the user's profile image, the user's system username, the user's professional title, the number of Endorsements 13 the user has received as well as the number of likes or “kudos” the user has received.

Examples of core platform functionality are also depicted in FIG. 2, including the home button protocol, search button protocol 12A, messaging button protocol, and profile button protocol 12B. In this embodiment, this suite of protocols makes the mobile application and its plurality of users, businesses, and opportunities accessible and viewable to all users, and are all necessary to the execution of the inventive concepts.

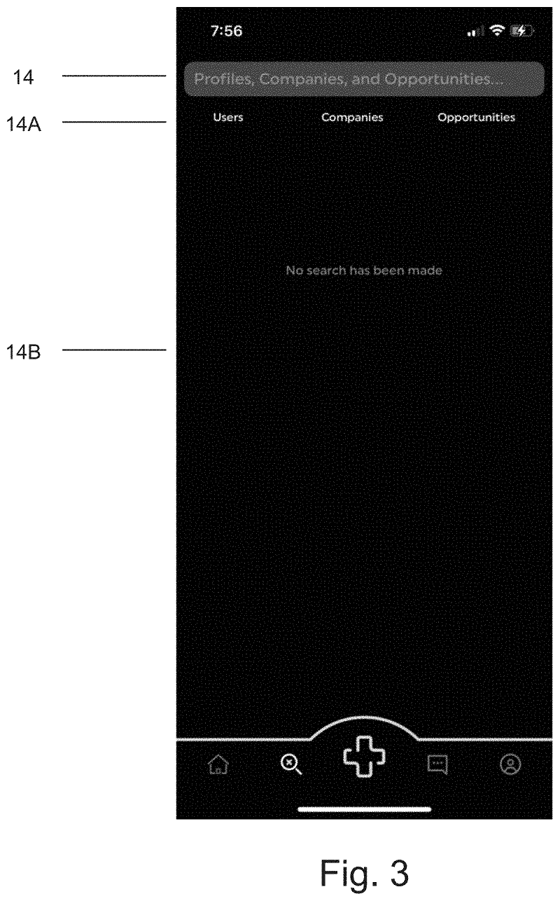

The search page 14 depicted in FIG. 3 illustrates the user's ability to search within the mobile application across three (3) primary search protocols: Users/Candidates, Businesses, and Opportunities 14A. For the purpose of this embodiment, the search ability of Users/Candidates is tantamount to the Endorsement 13 process. From this screen, the user, now referred to as the primary user, may search for other users on the platform to engage with to request an Endorsement 13. Until a user has input text, search results 14B remain blank.

In various embodiments, an Endorsement 13 can be a 30 second pre-recorded mobile video where a peer of the primary user summarizes the primary user's attributes, such as level of skill, level of experience, past work history, and previous accomplishments alongside abilities and qualities such as willingness-to-learn, team-building, confidence, directness, attentiveness, leadership and more. Endorsements 13 closely resemble the customary referrals any candidates secure when requested by a hiring business during the recruitment process. However, instead of real-time content typically conducted over the phone, Endorsements 13 are instantly available pre-recorded mobile video viewed on either a mobile device or desktop computer. In other embodiments, a length of the Endorsement can have different limit or, in some embodiments, no preset limit.

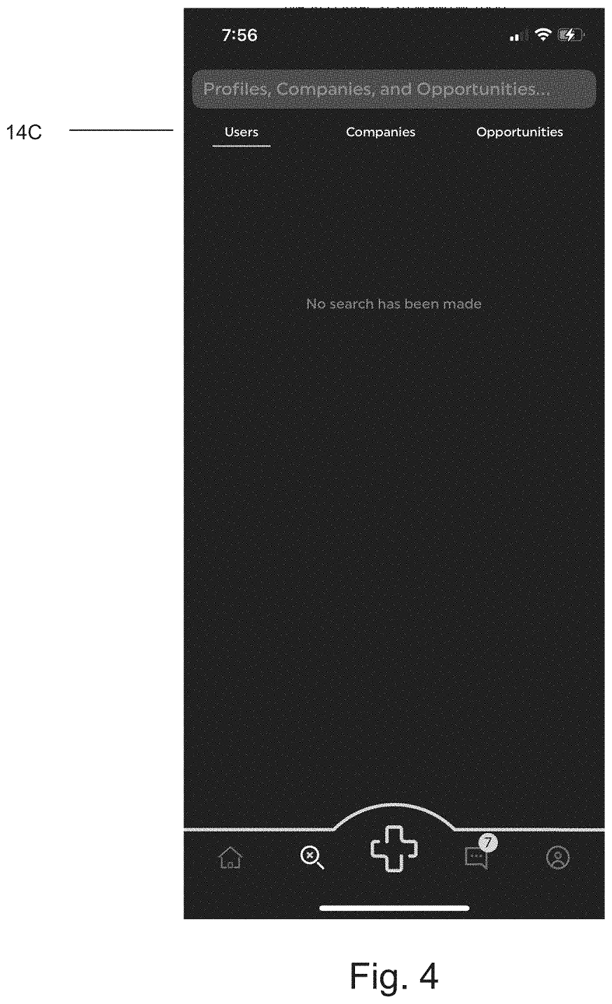

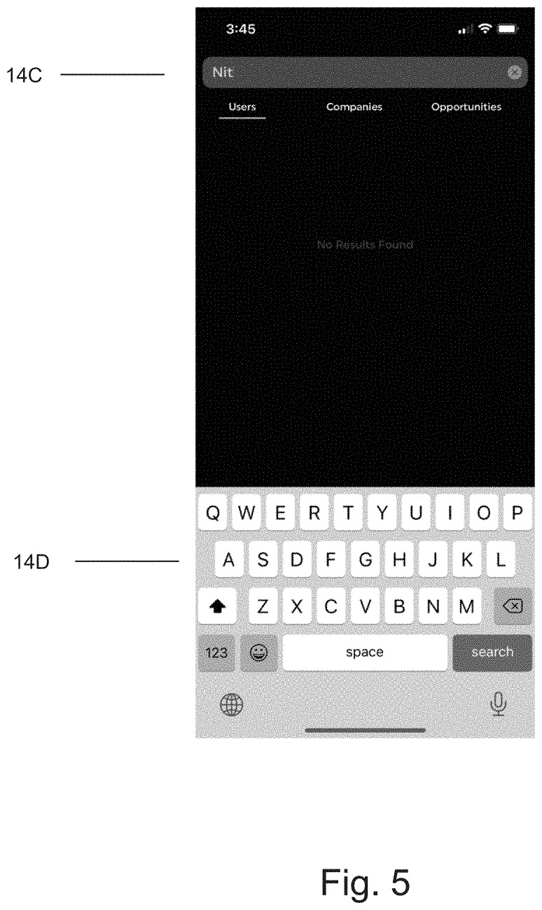

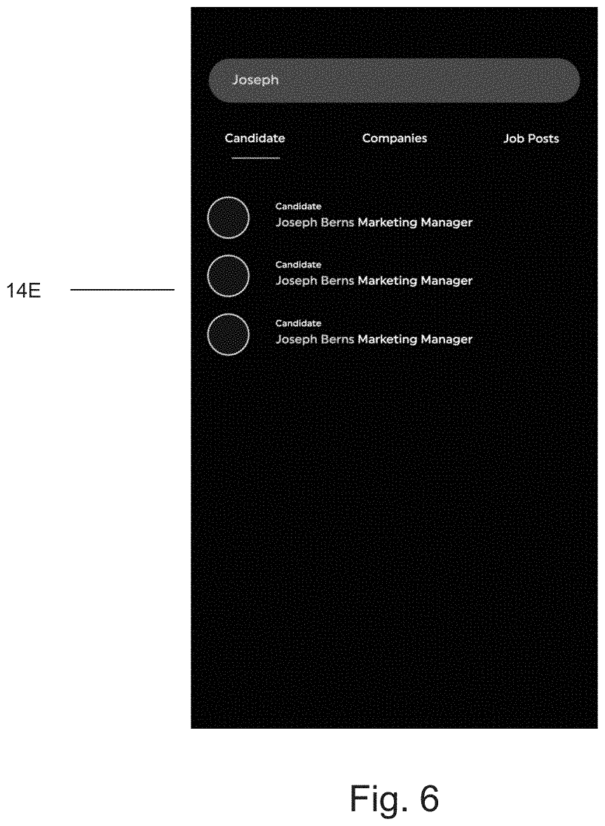

For the present embodiments, the User/Candidate search protocol is helpful in processing. FIG. 4 depicts an embodiment of the search page 14 in its User/Candidate selected state 14C, whereas FIG. 5 illustrates an embodiment of the search page functionality when a primary user is utilizing the operating system's native keyboard 14D to input search term 14C, such as a user's user name or first name-last name. FIG. 6 then depicts an embodiment of a completed search-result page 14E based on the primary user's text input.

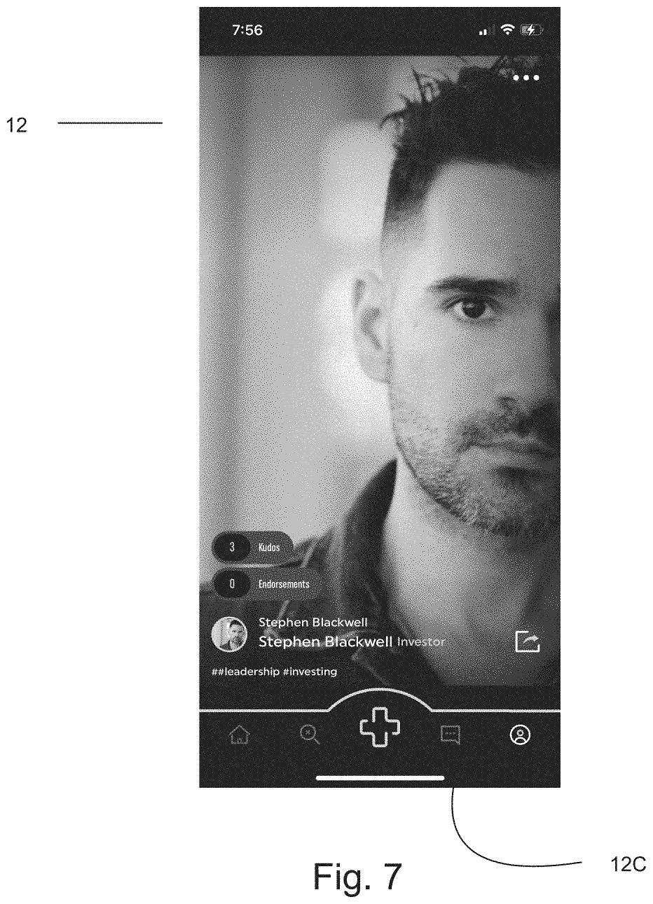

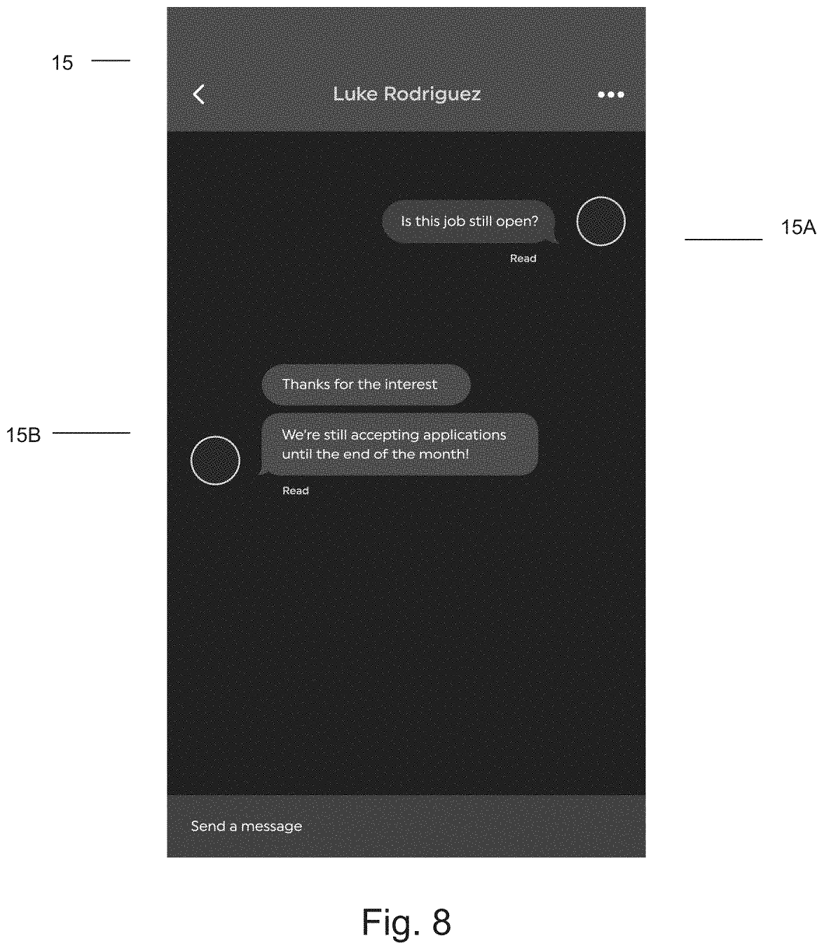

After the primary user completes their search, they can access the profile of the user 12 they wish to engage with to record an Endorsement, specifically by selecting the direct-message protocol 12C as illustrated in FIG. 7. Direct messages 15 may take place between mobile application users. FIG. 8 demonstrates an embodiment of an exchange where the primary user requests an Endorsement 15A from the engaged user, where the engaged user responds in agreement 15B.

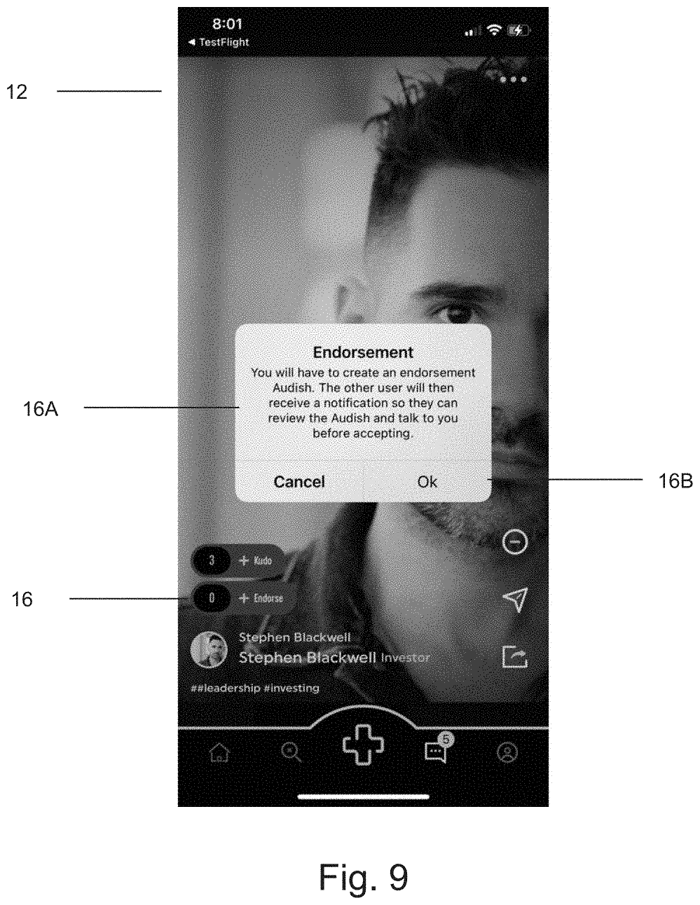

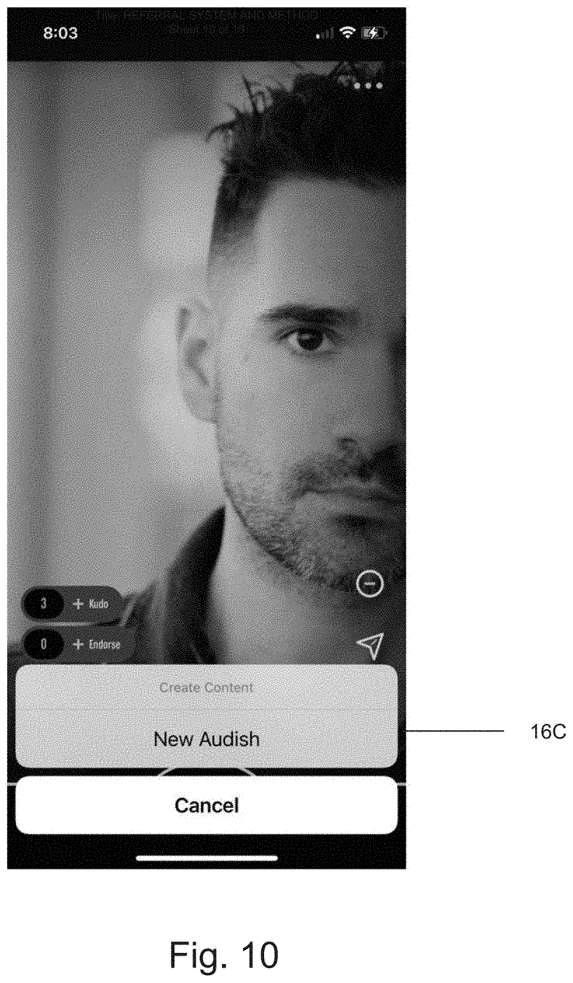

As illustrated in the embodiment of FIG. 9, the engaged user then accesses the primary user's profile 12 and selects the Endorse button 16 initiating the Endorsements 13 process with an instructional system prompt 16A that embodies the engaged user's choice to proceed by selecting Ok 16B. As depicted in the embodiment of FIG. 10, the initiation of the Endorsements 13 process concludes when the engaged user selects “New Endorsement” 16C, triggering the mobile applications camera tools and recording functionality.

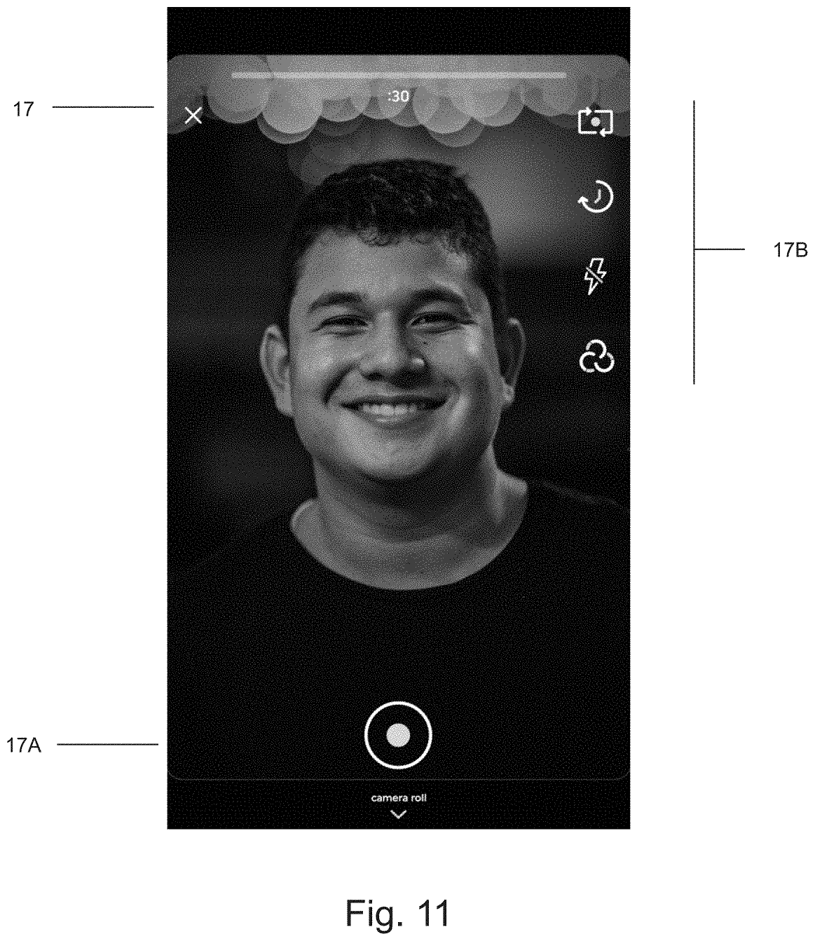

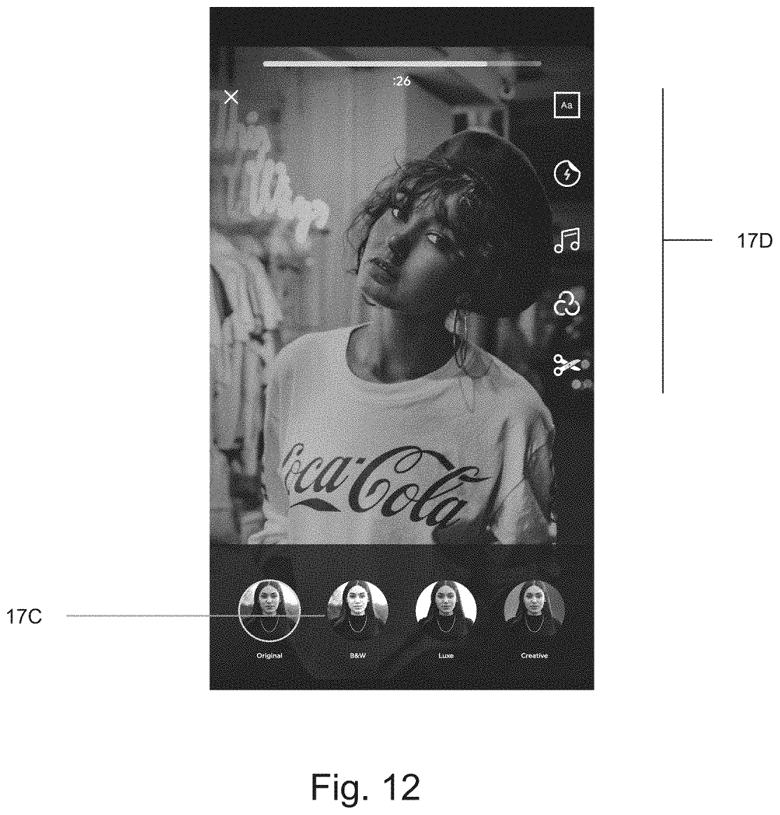

FIG. 11 depicts an embodiment of the mobile application's Record interface 17 inclusive of Record button 17A and associated camera tools such as timer, use flash, flip camera, and user filters 17B. In various embodiments, the mobile application's recording interface is essential to the creation of Endorsements 13. FIG. 12 depicts an embodiment of the playback of recorded Endorsements 13 inclusive of additional camera tools such as edit, add music, add stickers, and add text 17D. Potential filters, such as black & white and blur, are further depicted in 17C.

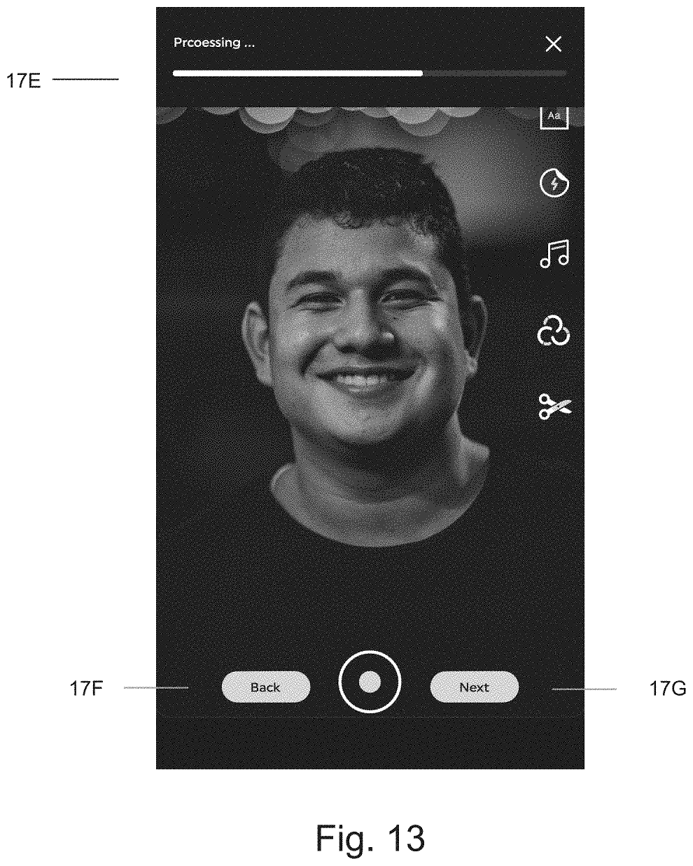

After engaged candidates have completed recording their Endorsements 13, the process concludes, as depicted in the embodiment of FIG. 13, with the recording interfaces processing screen, which includes the video processing bar 17E, that runs after the engaged user selects “Next” 17G. If the engaged user is unhappy with the results of their pre-recorded mobile video Endorsement 13, they may select “Back” 17F and return to the recording interface's edit screen depicted in FIG. 12.

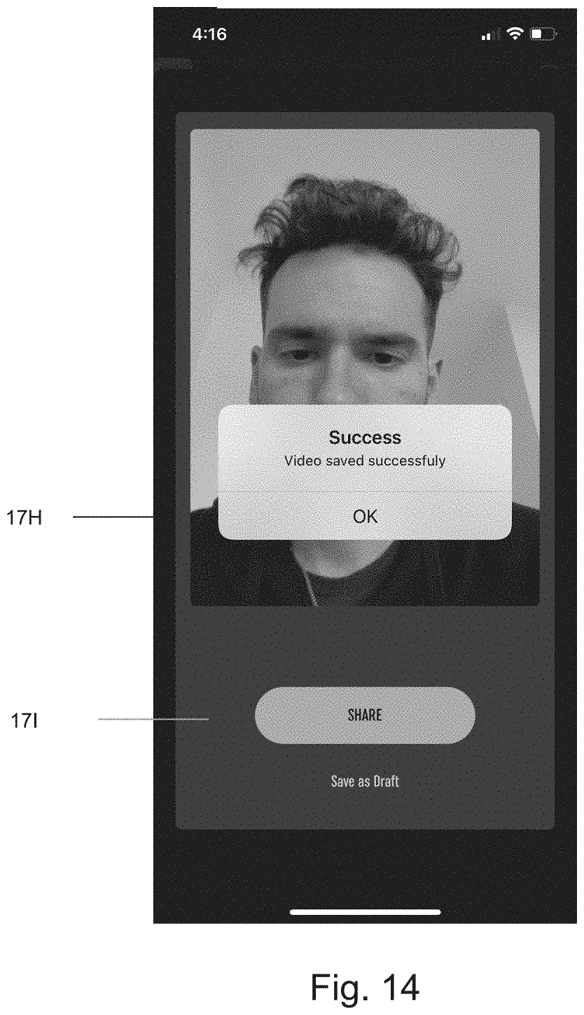

FIG. 14 depicts an embodiment of the recording interface's Share screen 171 that enables the engaged user to share the Endorsement 13 with the primary user by selecting OK in the saved successfully system prompt 1711 and then selecting Share 171.

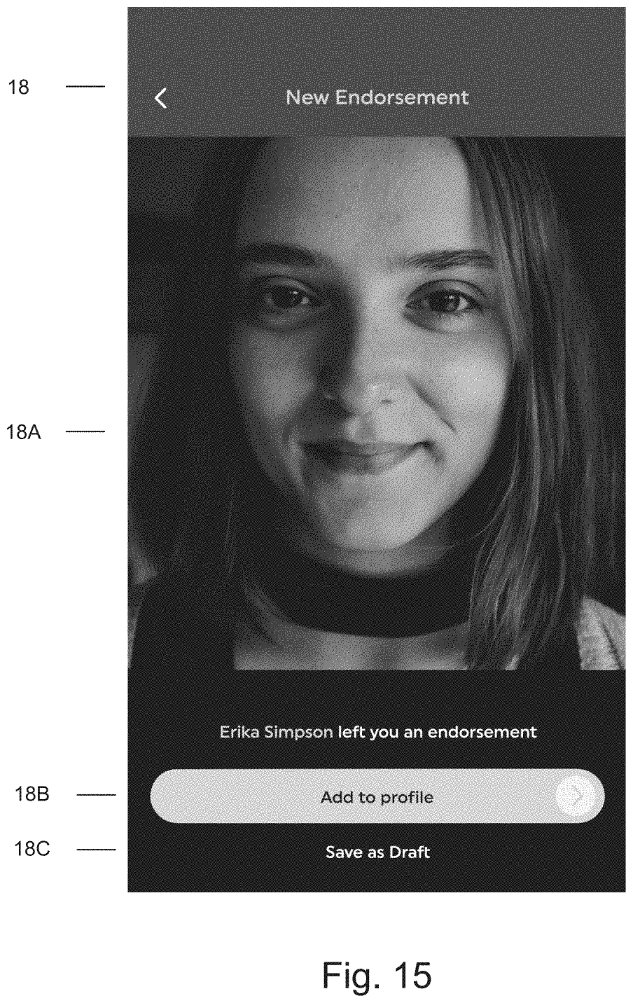

Upon submission of the Endorsement 13 by the engaged user, the primary user receives notification of the submission by direct message and is prompted to view the Endorsement 13 within the “New Endorsement” screen 18 as illustrated in the embodiment of FIG. 15. Within this screen the user may watch the submitted Endorsement 18A, add the submitted Endorsement to their profile 18B, or save the Endorsement as a draft 18C.

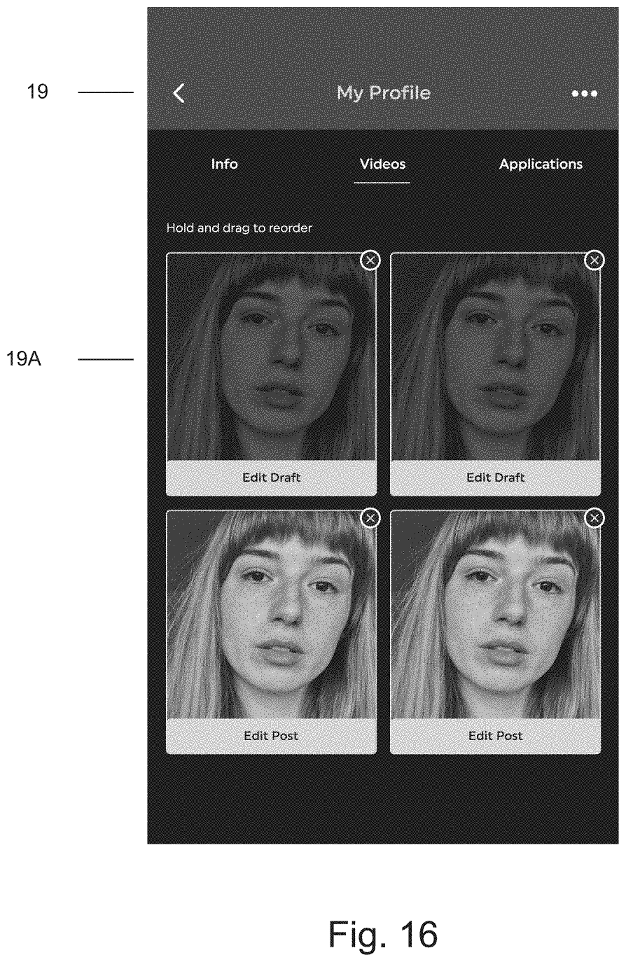

As illustrated in the embodiment of FIG. 16, after the primary user has approved the Endorsement 13, they may then position the Endorsement 13 as a video within their User Profile 12 utilizing the My Profile 19 drag and drop functionality of the editing protocols 19A within the mobile application. When this step in the mobile processing interface is complete, the engaged user's Endorsement 13 is available for consumption on the primary User Profile 12.

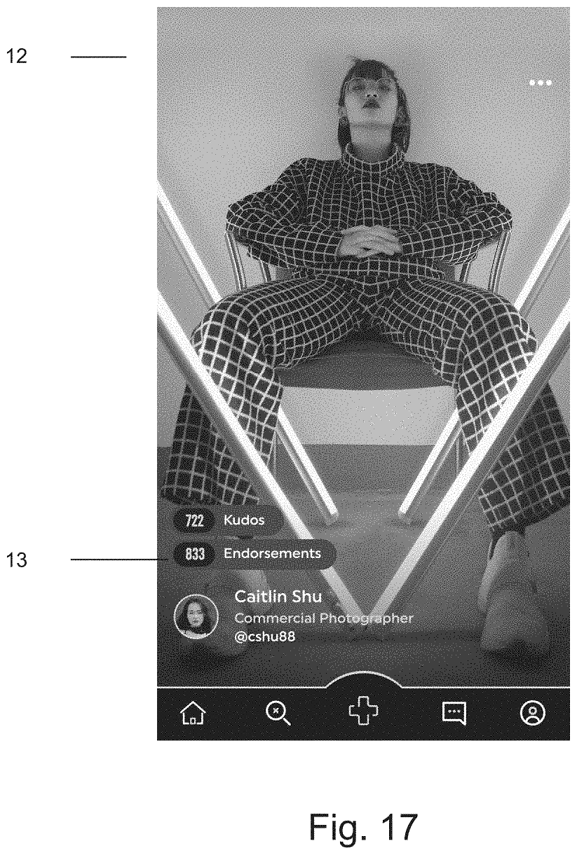

As depicted in FIG. 17, the Endorsements 13 are numerically quantified on the primary User Profile 12 and accessible for view within their profile. The primary user may easily share a public web link from the mobile application to the hiring businesses seeking referrals from the Candidate/User, saving meaningful time in the standard online recruitment process and removing the need for real-time, tele-based interactions. In various embodiments, the user may select specific Endorsements to be shared with specific hiring businesses.

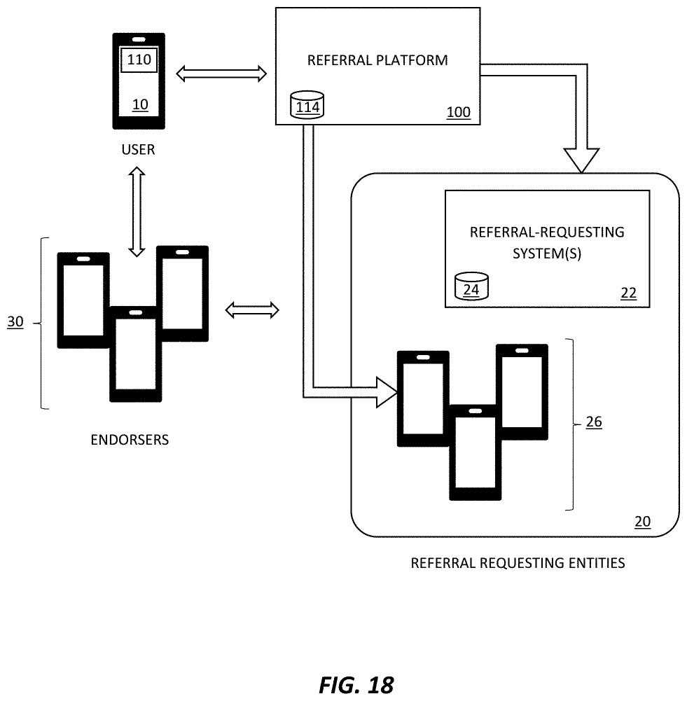

FIG. 18 is a diagram of a referral system in accordance with aspects of the inventive concepts. A referral system can comprise a referral platform 100 and a referral application 110 that communicate over any one or more of a plurality of networks, e.g., a cellular phone network, WiFi, the Internet, and so on. The referral application (or “app”) 110 and the referral platform 100 can operate collaboratively to carry out the methods and generate the UIs described above.

The referral application 110 can be executable on a mobile device, e.g., mobile phone, tablet, phablet. In various embodiments, the referral application 110 can also be executable on a laptop, desktop, or other user-interactive computer device, preferably comprising audiovisual input and output devices.

In some embodiments, the referral application 110 can be executable to generate UI screens on the mobile devices, receive user inputs, and activate the camera and microphone on the mobile devices to record Endorsements and/or Endorsement requests. The referral application 110 can also facilitate and perform communications with the referral platform 110, where user profiles may be stored and maintained in at least one database 114. The referral application can also perform and/or manage communications with systems and devices of referral requesters 20 and others (“Endorsers”) 30.

In various embodiments, a user of the user device 10, having the referral application 110 loaded and executing, can generate and send requests for Endorsements, i.e., Endorsement requests, to Endorsers. The Endorsement requests can be sent via the referral platform 100 and/or peer-to-peer from the user's mobile device 10 to mobile devices 30 of the Endorsers. The Endorsements can be recorded via the cameras and microphones of the Endorser mobile devices 30. The Endorsements may be sent to the referral platform 100 and the referral platform may send an electronic message comprising the Endorsements as a file and/or comprising a link the Endorsements on the referral platform 100. In some embodiments, the Endorsements could be sent directly from Endorsers to the user.

At the Endorser mobile devices 30, an instance of the referral application 110 can be downloaded and executed with the Endorsement request or a link to the referral platform can be provided for the Endorser to record its Endorsement. Either way, referral platform and/or referral application logic is executed to request, obtain, and communicate the Endorsement.

The Endorsement requests are generated so the user can be responsive to requests for referrals from an entity, e.g., a hiring manager at a potential employer 20 (“Referral Requester”). Once the user has obtained Endorsements from the Endorsers, the user, via the referral application 110 and/or the referral platform 100, can send an electronic message to the Referral Requester 20 providing the Endorsement files or a link to the Endorsement files. The Endorsements can be sent to mobile devices 26 of one or more individuals associated with the Referral Requester 20, e.g., a hiring manager or other talent acquisition individual or team. Endorsements could additionally, or alternative, be communicated to the Referral Requesting system 22 and stored in a database 24 of the Referral Requesting system 22.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

It will also be apparent that, while the examples used herein refer to hiring processes, the inventive concepts can be implemented in any context where referrals are used.

What is claimed is:

1. A mobile processing interface method comprising:
creating pre-recorded mobile video, at the request of a candidate seeking employment (“primary user”), by a peer (“engaged user”), for the purpose of referral to a hiring business,
including creating and/or editing the pre-recorded mobile video using camera tools, then electronically submitting the pre-recorded mobile video to the candidate for review,
in response to a candidate input the candidate approving the pre-recorded mobile video; and
electronically publishing the approved pre-recorded mobile video for public view via a candidate profile.

2. A referral system, comprising:
a referral application executable on or via a mobile device; and
a computer-based referral platform configured to store and manage a plurality of user profiles and to communicate with a plurality of mobile devices executing the referral application,
wherein the referral application is responsive to a user input via a user profile on a user mobile device to generate an Endorsement request to one or more mobile devices of endorsing users, the Endorsement request soliciting an audiovisual input from the endorsing users of the one or more other mobile devices, and
wherein the referral application is executable to activate a microphone and camera on the one or more other mobile devices to record audiovisual inputs from the endorsing users as recorded Endorsements responsive to the Endorsement request.

3. The system of claim 2, wherein the referral application is executable to communicate the recorded Endorsements from the one or more other mobile devices of the endorsing users to the user mobile device and/or the referral platform.

4. The system of claim 2, wherein the referral application and/or the referral platform are responsive to a user input via the referral application to communicate an electronic message to at least one referral-requesting system indicating availability of one or more of the recorded Endorsements.

5. The system of claim 4, wherein the electronic message includes at least one Endorsement and/or an active link to at least one Endorsement.

6. The system of claim 5, wherein the referral application and/or the referral platform are configured to generate a message to the mobile device of the user indicating that the at least one Endorsement has been downloaded or executed (played).

7. The system of claim 2, wherein the referral application is configured to impose a predetermined time constraint to the audiovisual recordings.

8. A computer-based referral method, comprising:
providing a referral application executable on or via a mobile device;
providing a computer-based referral platform configured to store and manage a plurality of user profiles and to communicate with a plurality of mobile devices executing the referral application;
in response to a user input via a user profile on a user mobile device, the referral application generating an Endorsement request to one or more mobile devices of endorsing users, the Endorsement request soliciting an audiovisual input from the endorsing users of the one or more other mobile devices; and
the referral application activating a microphone and camera on the one or more other mobile devices to record audiovisual inputs from the endorsing users as recorded Endorsements responsive to the Endorsement request.

9. The method of claim 8, further comprising:
the referral application communicating the recorded Endorsements from the one or more other mobile devices of the endorsing users to the user mobile device and/or the referral platform.

10. The method of claim 8, further comprising:
in response to a user input via the referral application, the referral application and/or the referral platform communicating an electronic message to at least one referral-requesting system indicating availability of one or more of the recorded Endorsements.

11. The method of claim 10, wherein the electronic message includes at least one Endorsement and/or an active link to at least one Endorsement.

12. The method of claim 11, further comprising:
the referral application and/or the referral platform generating a message to the mobile device of the user indicating that the at least one Endorsement has been downloaded or executed (played).

13. The method of claim 8, further comprising:
the referral application imposing a predetermined time constraint to the audiovisual recordings.
